(19) United States
(12) Patent Application Publication
(10) Pub. No.: US 2013/0074544 A1
(43) Pub. Date: Mar. 28, 2013

(54) Text messaging novelty jewelry

(71) Applicant: Maris J. Lans, Highland Park, IL (US)

(72) Inventor: Maris J. Lans, Highland Park, IL (US)

(73) Assignee: MAR2MAR, INC.

(21) Appl. No.: 13/137,965

(22) Filed: Sep. 22, 2011

(51) Int. Cl. A44C 5/00; G09F 3/00; A44C 25/00

(52) U.S. Cl. 63/1.13; 40/300; 40/6

(57) ABSTRACT

A novelty jewelry item generally comprising tiles having any combination of characters, for example ASCII characters, other symbols, text messaging terminology, English language text, foreign language text, and arbitrary and/or graphical designs formed thereon. The tiles may be inserted into an accommodatingly shaped receptacle, which in turn is mounted on a jewelry item, for example a bracelet, necklace, or “dog tag” such that the user is able to create novelty jewelry displaying a user selected message.

### RELATED APPLICATIONS

There are no related applications.

STATEMENT REGARDING FEDERALLY SPONSORED RESEARCH OR DEVELOPMENT

Not applicable.

REFERENCE TO SEQUENCE LISTING, A TABLE, OR A COMPUTER PROGRAM LISTING COMPACT DISC APPENDIX

None.

### FIELD OF THE INVENTION

The present invention generally relates to jewelry, and more particularly, to novelty jewelry, identification tags, bracelets and the like that may be customized by the user to display selected alphanumeric characters or combinations thereof, symbols, graphical designs, and the like representing text messages currently in use by the consuming public.

### BACKGROUND OF THE INVENTION

People of all ages enjoy buying and wearing jewelry and other decorative articles. Additionally, novelty items reflecting current fads or trends are popular, particularly if they are available at nominal cost. Moreover, while these decorative articles generally serve an essentially ornamental purpose, they may also be used for purposes other than their ornamental aspects. For example, these otherwise decorative items may be used as an identifying device for one's person or luggage, or expressing one's convictions or presenting a personalized message to the public or a friend, etc.

No longer a mere fad or trend, the twenty-first century has in fact become an age of instant communication. In particular, mobile means of communications have essentially become ubiquitous and it is believed that the great majority of Americans own or otherwise have access to mobile telephones. Interestingly, however, these handsets are being used less and less for voice communications. Rather, the Short Message Service (SMS) or so-called text messaging feature available in these handsets is quickly becoming the communications medium of choice for the young and old, whether male or female. In fact, text messaging has become sufficiently popular that a shorthand language has developed as a result of the limited message length (generally 160 characters or less) supported by this technology. Accordingly, “LOL” is now almost universally understood to represent the phrase “laugh out loud.” Similarly, “OMDB” is understood to represent the more ominous “over my dead body” and “MYOB” is understood to represent “mind your own business.” Multitudes of similar shorthand words now exist, for example, “LH6”, “WTF”, “KMA”, “KPC”, “SUX”, and the like.

The combination of these two distinct phenomena, namely, the desire of the general public for jewelry and similar decorative items, and the ascendance of text messaging in lieu of voice communications, e-mail, instant messaging, and the like form the basis of the present invention.

### SUMMARY OF THE INVENTION

The present invention contemplates the incorporation of text messages and the like into modular, novelty jewelry that may be customized as desired by the user. In a preferred embodiment the invention comprises a flexible rectilinear tile having a selected alphanumeric character string molded thereon. The alphanumeric characters are typically molded in a contrasting color. It is contemplated that the messages may comprise any combination of alphanumeric characters, including those defined by the American Standard Code for Information Interchange (ASCII) and any other graphical representation or symbologies. In addition a receptacle frame is provided, sized to accommodate the tiles, and the receptacle frame in turn is aesthetically mounted or otherwise incorporated into a novelty jewelry item, for example a bracelet, necklace, luggage tag, or the like.

It is an object of this invention to provide customizable jewelry presenting text messages.

It is another object of this invention to provide novelty jewelry displaying a user selected text message.

It is yet another object of this invention to provide jewelry displaying text messaging terminology; and

It is an object of this invention to provide jewelry that is constantly changeable or updatable with regard to phrases, messages, and the like.

The invention will be better understood and objects other than those set forth above will become apparent when consideration is given to the following detailed description thereof. Such description makes reference to the annexed drawings wherein.

### BRIEF DESCRIPTION OF THE DRAWINGS

FIG. 1 is a top plan view of a bracelet embodiment of the present invention;

FIG. 2 is a side elevation view of the bracelet embodiment shown in FIG. 1;

FIG. 3 is a perspective view of the bracelet embodiment shown in FIGS. 1 and 2, showing the inventive device mounted on the wearer's wrist; and,

FIG. 4 is a top plan view of a necklace embodiment of the present invention.

### DETAILED DESCRIPTION OF THE INVENTION

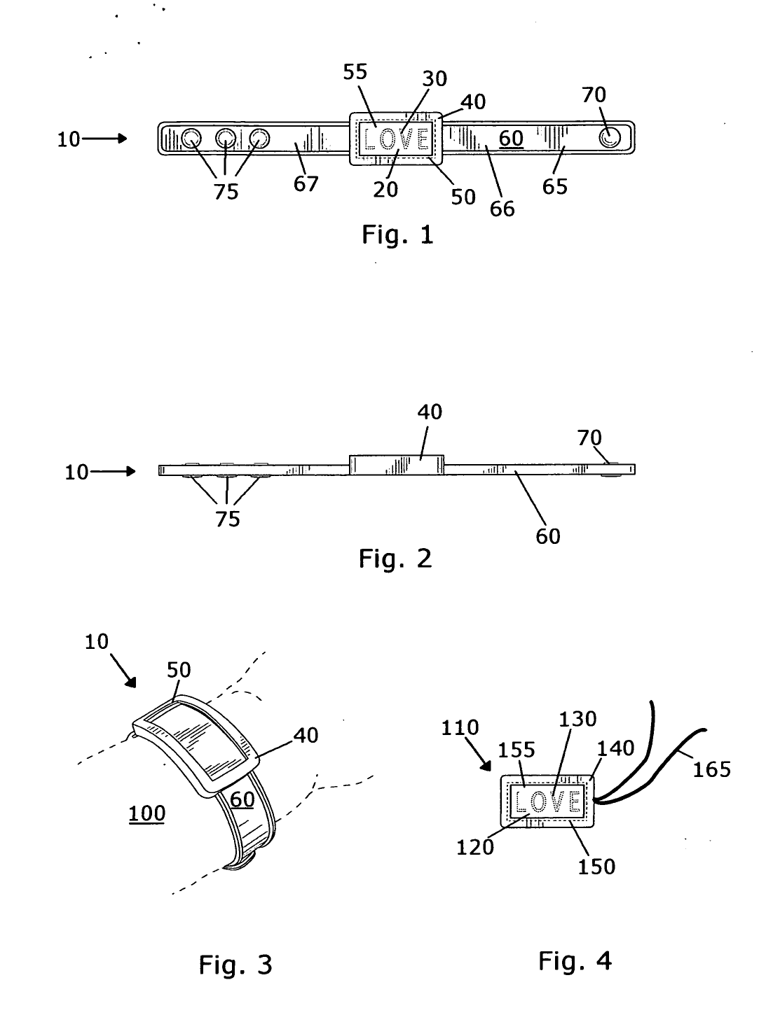

The preferred embodiment and best mode of the invention is shown in FIGS. 1 through 4. It may be manufactured from any flexible, formable and/or moldable material and in this preferred embodiment is manufactured from elastomeric materials such as plastic in various colors, textures, and designs. It is contemplated that the invention may be embodied in various forms, for example a bracelet, a necklace, a “dog tag”, luggage tag, and the like. While the invention is described in connection with these embodiments, it is not intended that the invention be so limited. On the contrary, it is intended to cover all alternatives, modifications, and equivalent arrangements as may be included within the spirit and scope of the invention as defined by the appended claims.

Turning to FIGS. 1 and 2, one embodiment of the present invention is shown in the form of a bracelet 10. The invention includes a text tile 20 (shown in phantom) formed from a flexible material, for example an elastomeric plastic material. In this preferred embodiment the tile 20 is generally rectilinear in shape, measuring about 1.5 inches by about 0.75 inches. It is contemplated, however, that the tile 20 may be formed in any shape, for example in the form of a circle or oval, or an irregular shape. Alphanumeric characters 30 (shown in phantom) are formed on the tile 20 and may comprise any combination of characters, for example ASCII characters, other symbols, text messaging terminology, English language text, foreign language text, and arbitrary and/or graphical designs. In a preferred embodiment the aforementioned text 30 is formed in a color that contrasts with that of the tile 20. For example, the tile 20 may be formed in a black elastomeric material while the text 30 may be formed in a contrasting primary color. Nearly infinite color combinations exist and may include different gradations of the same base color, metallic colors, and flat or glossy finishes.

A receptacle frame 40 is provided, sized to accommodate and secure the tile 20 by its exterior margin such that the alphanumeric characters or text 30 is clearly visible. In this embodiment, the receptacle 40 includes a retaining lip 50 defining an opening 55 in the receptacle 40 having dimensions slightly smaller than the dimensions of the tile 20 such that a tile 20 may be pressed into the receptacle 40 in such a manner that the retaining lip 50 will secure the tile 20 therein. Those skilled in the art will understand that numerous retention mechanisms are known and are implicitly incorporated herein.

The rectilinear frame receptacle 40 is mounted to a bracelet 60 comprising a strap 65 having female snap closure 70 mounted at a first end 66 and a plurality of male snap closures 75 mounted at the second, opposing end 67. In use the female snap closure 70 may be mated to any of the plurality of male closures 75 in order to accommodate any wrist size. It is also understood that numerous closure mechanisms are known and those skilled in the art will understand that any such closure mechanism may be used with equal success herein. Such mechanisms include but are not limited to hook and loop closures, buckles, and free ends that are simply tied to one another. Additionally, the bracelet 10 may be formed in a continuous conformation similar to, for example, a rubber band such that the apparatus is simply slipped over the hand (or foot) and worn about the wrist (or ankle).

FIG. 3 shows the bracelet 10 invention of the present application in place, being worn about the wrist 100 (shown in phantom) of the wearer. In use, it is contemplated that numerous combinations of tiles 20 having an essentially unlimited variety of text 30 messages, designs, etc. will be available. Moreover, the design of the present invention 10 facilitates constant updating whereby text 30 not yet in use may be incorporated into additional tiles 20 as desired, with the result that the wearer and device will continue to be up-to-date indefinitely. The wearer simply selects the tile 20 of her or his choice according to their mood, whim, and desire and thereafter simply inserts same into the receptacle 40 in order to create a unique, custom, novelty jewelry item.

Turning to FIG. 4 another embodiment of the present invention is shown in the form of a necklace 110. The invention includes a text tile 120 (shown in phantom) formed from a flexible material, for example an elastomeric plastic material. In this preferred embodiment the tile 120 is generally rectilinear in shape, measuring about 1.5 inches by about 0.75 inches. It is contemplated, however, that the tile 120 may be formed in any shape, for example in the form of a circle or oval, or an irregular shape. Alphanumeric characters 130 (shown in phantom) are formed on the tile 120 and may comprise any combination of characters, for example ASCII characters, other symbols, text messaging terminology, English language text, foreign language text, and arbitrary and/or graphical designs. In a preferred embodiment the aforementioned text 130 is formed in a color that contrasts with that of the tile 120. For example, the tile 120 may be formed in a black elastomeric material while the text 130 may be formed in a contrasting primary color. Nearly infinite color combinations exist and may include different gradations of the same base color, metallic colors, and flat or glossy finishes.

A receptacle frame 140 is provided, sized to accommodate and secure the tile 120 by its exterior margin such that the alphanumeric characters or text 130 is clearly visible. In this embodiment, the receptacle 140 includes a retaining lip 150 defining an opening 155 in the receptacle 140 having dimensions slightly smaller than the dimensions of the tile 120 such that a tile 120 may be pressed into the receptacle 40 in such a manner that the retaining lip 150 will secure the tile 120 therein. Those skilled in the art will understand that numerous retention mechanisms are known and are implicitly incorporated herein. The rectilinear frame receptacle 140 is subsequently mounted to a necklace chain, lanyard, or the like 165.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

1. A jewelry item comprising:
a flexible tile having symbologies formed thereon;
said tile being removably insertable in a receptacle;
said receptacle being mounted to the jewelry item; and,
said jewelry item being selected from the group consisting of a bracelet, a necklace, a dog tag, and a luggage tag.

2. (canceled)

3. The jewelry item as claimed in claim 1 wherein said symbologies are alphanumeric characters.

4. The jewelry item as claimed in claim 1 wherein said symbologies are American Standard Code for Information Interchange (ASCII) characters.

5. The jewelry item as claimed in claim 1 wherein said symbologies are text messages.

6. The jewelry item as claimed in claim 1 wherein said symbologies are English language characters.

7. The jewelry item as claimed in claim 1 wherein said symbologies are foreign language characters.

8. The jewelry item as claimed in claim 1 wherein said tile is rectilinear and said receptacle is shaped to accommodate said tile.

9. The jewelry item as claimed in claim 8 wherein said rectilinear tile measures about 1.5 inches by about 0.75 inches.

10. A novelty non-metallic jewelry item comprising:
a flexible rectilinear tile having symbologies formed thereon;
said rectilinear tile being insertably mountable in a receptacle frame allowing visualization of said symbologies; and,
said receptacle frame being mounted to a bracelet wrist band with fastening means to connect ends of said band together.

11. The novelty jewelry item as claimed in claim 10 wherein said symbologies are alphanumeric characters.

12. The novelty jewelry item as claimed in claim 10 wherein said symbologies are American Standard Code for Information Interchange (ASCII) characters.

13. The novelty jewelry item as claimed in claim 10 wherein said symbologies are text messages.

14. The novelty jewelry item as claimed in claim 10 wherein said symbologies are English language characters.

15. The novelty jewelry item as claimed in claim 10 wherein said symbologies are foreign language characters.

16. The novelty jewelry item as claimed in claim 10 wherein said fastening means is selected from a group consisting of hook and loop closure material, buckles and band holes, snaps and slides.

17. The novelty jewelry item as claimed in claim 16 wherein said rectilinear tile measures about 1.5 inches by about 0.75 inches.

18. A novelty non-metallic jewelry item comprising:
a flexible tile having symbologies formed thereon;
said tile being removably insertable in a receptacle frame allowing visualization of the symbologies; and,
said receptacle frame being mounted to a chain, said chain being provided with a snap closure component at one end.

19. (canceled)

20. The novelty jewelry item as claimed in claim 18 wherein said symbologies are selected from the group consisting of alphanumeric characters, American Standard Code for Information Interchange (ASCII) characters, text messages, English language characters, and foreign language characters
